(19) United States
(12) Patent Application Publication
(10) Pub. No.: US 2012/0165448 A1
(43) Pub. Date: Jun. 28, 2012

(54) Polyamide Resin Composition

(75) Inventors: Sang Hwa Lee, Seoul (KR); In Sik Shim, Incheon (KR); Pil Ho Kim, Gunpo-si (KR); In Geol Baek, Seoul (KR); Jong Cheol Lim, Anyang-si (KR)

(73) Assignee: CHEIL INDUSTRIES INC., Gumi-si (KR)

(21) Appl. No.: 13/332,788

(22) Filed: Dec. 21, 2011

(30) Foreign Application Priority Data
Dec. 28, 2010 (KR) 10-2010-0136380
Nov. 23, 2011 (KR) 10-2011-0122711

(51) Int. Cl. C08L 77/06; C08K 3/22; C08K 3/30; C08K 3/36; C08K 5/17; C08K 3/32; C08K 3/34; C08K 7/14; C08K 3/26

(52) U.S. Cl. 524/236; 524/538; 524/494; 524/413; 524/420; 524/424; 524/423; 524/430; 524/425; 524/432; 524/433; 524/417; 524/449; 524/451; 524/447

(57) ABSTRACT

A polyamide resin composition according to the present invention comprises (A) about 10 to about 70% by weight of crystalline polyamide resin, (B) about 10 to about 70% by weight of amorphous polyamide resin with a glass transition temperature of about 110 to about 200° C., (C) about 10 to about 60% by weight of inorganic filler, (D) about 10 to about 50% by weight of white pigment, and (E) about 0.05 to about 2 parts by weight of light stabilizer, based on about 100 parts by weight of the crystalline polyamide resin (A), the amorphous polyamide resin (B), the inorganic filler (C) and the white pigment (D), and can have excellent surface reflectance, heat resistance, mechanical strength, moldability, light stability and discoloration resistance.

### CROSS-REFERENCE TO RELATED APPLICATION

This application claims priority under 35 USC Section 119 to and the benefit of Korea Patent Application No. 10-2010-0136380 filed on Dec. 28, 2010, and Korea Patent Application No. 10-2011-0122711 filed on Nov. 23, 2011, in the Korean Intellectual Property Office, the disclosure of each of which is incorporated herein by reference in its entirety.

### FIELD OF THE INVENTION

The present invention relates to a polyamide resin composition.

### BACKGROUND OF THE INVENTION

Reflectors are used in various products in order to use light more effectively. Recently, many products include a light source in the form of a semiconductor, i.e. semiconductor laser, light emitting diode (hereinafter, LED), and the like, to allow miniaturization of the device and light source. Reflectors for LEDs and resin compositions for the preparation thereof can require properties such as high light reflectance, high whiteness, good moldability, high dimensional stability, high mechanical strength, high heat resistance and the like.

For example, reflectors used for LEDs can require not only mechanical strength but also heat resistance because the reflectors are surface mounted onto, for example, a printed circuit board. Reflectors for LEDs can also require excellent moldability due to the miniaturization of the device. Also, reflectors can require high reflectance, and in particular the ability to inhibit the degradation of reflectance due to exposure to heating during the process of assembling the LED and the process of reflow soldering. Also, reflectors can be made using a particular insert molding method to obtain a reflector with high reflectance, and accordingly a resin composition which can be used in such a method can also be required.

Conventionally, liquid crystal polymers (LCPs) or heat-resistant polyamide resins were used as materials able to resist temperatures during reflow soldering using lead-free solder (typically 260° C.). LCP has excellent heat resistance, light stability and moldability. However, adhesion of the LCP with a sealing resin such as epoxy resin, which is used after mounting the LED to the reflector, can deteriorate. Also, LCPs can have low whiteness and thus it can be difficult to provide high reflectance thereto. Aliphatic polyamides (such as PA6, PA66, PA11, and PA12) can have excellent strength properties and injection moldability. Aliphatic polyamides do not, however, have heat resistance sufficient to resist temperatures during reflow soldering and further cannot have low hygroscopicity. Also aliphatic polyamides can suffer deteriorated reflectance due to discoloration that can occur during heating.

Japanese Patent Application Publication No. 2000-204244 is directed to a polyamide composition comprising a polyamide having a dicarboxylic acid unit including 60 to 100 mol % of a terephthalic acid unit and a diamine unit including 60 to 100 mol % of a C6 to C18 aliphatic alkylenediamine unit, and inorganic filler with a certain average particle diameter. The composition can have good heat resistance at the time of moisture absorption, dimensional stability, surface evenness and surface appearance, but does not sufficiently inhibit degradation of light reflectance due to discoloration.

International Patent Application Publication No. 2003-085029 and Japanese Patent Application Publication No. 1995-228776 are directed to a resin composition for a reflector comprising polyamide resin consisting of 1,9-diaminononane and inorganic filler. However, the resin composition does not adhere well to a sealing resin.

Japanese Patent Application Publication No. 2002-294070 is directed to a polyamide resin including potassium titanate fiber and/or wollastonite. However, the resin does not have sufficient strength when molding, and it can be difficult to use when insert molding.

Japanese Patent Application Publication No. 2004-075994 is directed to a polyamide composition useful for articles and lamp reflector materials with high whiteness and high surface reflectance. The polyamide composition has higher heat resistance than a resin composition using a conventional heat-resistant polyamide such as PA6T or PA46 and the like, but does not completely solve the discoloration problem resulting from exposure to heat.

### SUMMARY OF THE INVENTION

The present invention relates to a polyamide resin composition that can have excellent surface reflectance and heat resistance. The polyamide composition can also have excellent mechanical strength, moldability, light stability, and discoloration resistance. The present invention also provides a molded article prepared from the polyamide resin composition.

A polyamide resin composition according to the present invention comprises (A) about 10 to about 70% by weight of crystalline polyamide resin, (B) about 10 to about 70% by weight of amorphous polyamide resin with a glass transition temperature (Tg) of about 110 to about 200° C., (C) about 10 to about 60% by weight of inorganic filler, (D) about 10 to about 50% by weight of white pigment, and (E) about 0.05 to about 2 parts by weight of a light stabilizer, based on about 100 parts by weight of the crystalline polyamide resin (A), the amorphous polyamide resin (B), the inorganic filler (C) and the white pigment (D).

In exemplary embodiments of the present invention, the polyamide resin composition further comprises (F) about 0.05 to about 3 parts by weight of inorganic particles, based on about 100 parts by weight of the crystalline polyamide resin (A), the amorphous polyamide resin (B), the inorganic filler (C) and the white pigment (D).

In exemplary embodiments of the present invention, the crystalline polyamide resin (A) can have a melting point of about 260 to about 350° C., a crystallization temperature of about 260 to about 320° C., and a glass transition temperature of less than about 100° C.

In exemplary embodiments of the present invention, the crystalline polyamide resin (A) comprises (a-1) units derived from dicarboxylic acid and (a-2) units derived from diamine; wherein the units derived from dicarboxylic acid (a-1) comprise about 30 to about 100 mol % of units derived from terephthalic acid, and about 0 to about 70 mol % of units derived from aromatic dicarboxylic acid other than terephthalic acid, about 0 to about 70 mol % of units derived from C4 to C20 aliphatic dicarboxylic acid or about 0 to about 70 mol % of a combination of the units derived from aromatic dicarboxylic acid other than terephthalic acid and the units derived from C4 to C20 aliphatic dicarboxylic acid; and the units derived from diamine (a-2) comprise units derived from C4 to C20 linear aliphatic diamine, branched aliphatic diamine, or a combination thereof.

In exemplary embodiments of the present invention, the amorphous polyamide resin (B) has a glass transition temperature of about 120 to about 160° C.

In exemplary embodiments of the present invention, the amorphous polyamide resin (B) comprises a polyamide prepared from terephthalic acid, 2,2,4-trimethyl hexamethylene diamine and 2,4,4-trimethyl hexamethylene diamine; polyamide prepared from isophthalic acid and 1,6-hexamethylene diamine; polyamide prepared from terephthalic acid, isophthalic acid and 1,6-hexamethylene diamine; copolyamide prepared from isophthalic acid, 3,3′-dimethyl-4,4′-diaminodicyclohexylmethane and laurolactam; polyamide prepared from 1,12-dodecane dicarboxylic acid and 4,4′-diaminodicyclohexylmethane; copolyamide prepared from terephthalic acid, isophthalic acid, 3,3′-dimethyl-4,4′-diaminodicyclohexylmethane and laurolactam; or a combination thereof.

In exemplary embodiments of the present invention, the inorganic filler (C) comprises a glass fiber with an average length of about 0.1 to about 20 mm and an aspect ratio of about 10 to about 2,000.

In exemplary embodiments of the present invention, the white pigment (D) comprises titanium oxide, zinc sulfide, white lead, zinc sulfate, aluminum oxide or a combination thereof.

In exemplary embodiments of the present invention, the light stabilizer (E) comprises a hindered amine-based compound.

In exemplary embodiments of the present invention, the inorganic particle (F) comprises calcium carbonate, magnesium carbonate, zinc carbonate, zinc oxide, barium sulfate, zinc sulfide, alkaline carbonate, titanated mica, antimony oxide, magnesium oxide, calcium phosphate, silica, alumina, mica, talc, kaolin or a combination thereof.

In exemplary embodiments of the present invention, the polyamide resin composition further comprises an additive comprising an antioxidant, heat stabilizer, flame retardant, fluorescent whitening agent, plasticizer, thickener, antistatic agent, releasing agent, pigment, nucleating agent or a combination thereof.

A molded article according to the present invention is prepared from the polyamide resin composition.

In exemplary embodiments of the present invention, the molded article can have a reflectance of about 80 to about 90% at a 440 nm wavelength light, which is measured after the molded article is illuminated by a LED light source having a wavelength of 460 nm for 200 hours.

In exemplary embodiments of the present invention, the molded article can have a yellow index of about 1 to about 5, which is measured after the article is illuminated by a LED light source having a wavelength of 460 nm for 200 hours.

The polyamide resin composition according to the present invention can have excellent surface reflectance, heat resistance, mechanical strength, moldability, light stability and discoloration resistance.

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein; rather, these embodiments are provided so that this disclosure will satisfy applicable legal requirements.

A polyamide resin composition according to the present invention comprises (A) about 10 to about 70% by weight of crystalline polyamide resin, (B) about 10 to about 70% by weight of amorphous polyamide resin with a glass transition temperature of about 110 to about 200° C., (C) about 10 to about 60% by weight of inorganic filler, (D) about 10 to about 50% by weight of white pigment, and (E) about 0.05 to about 2 parts by weight of a light stabilizer, based on about 100 parts by weight of the crystalline polyamide resin (A), the amorphous polyamide resin (B), the inorganic filler (C) and the white pigment (D).

(A) Crystalline Polyamide Resin

The crystalline polyamide resin comprises (a-1) units derived from dicarboxylic acid and (a-2) units derived from diamine.

(a-1) Units Derived from Dicarboxylic Acid

The term “units derived from dicarboxylic acid” refers to residues of dicarboxylic acid from which hydroxyl groups positioned at both ends of dicarboxylic acid are removed. Examples of the dicarboxylic acid comprise aromatic dicarboxylic acids, aliphatic dicarboxylic acids, and combinations thereof.

Examples of the aromatic dicarboxylic acid comprise without limitation terephthalic acid, isophthalic acid, 2-methylterephthalic acid, naphthalene dicarboxylic acid and the like. These can be used alone or in combination thereof.

The number of carbon atom of the aliphatic dicarboxylic acid is not limited specifically, and can range from 4 to 20, for example 6 to 12. Examples of the aliphatic dicarboxylic acid comprise without limitation adipic acid, suberic acid, azelaic acid, sebacic acid, decane dicarboxylic acid, undecane dicarboxylic acid, dodecane dicarboxylic acid and the like. These can be used alone or in combination thereof. In exemplary embodiments, adipic acid can be used.

In exemplary embodiments of the present invention, the units derived from dicarboxylic acid comprise units derived from terephthalic acid in an amount of about 30 to about 100 mol %, for example about 40 to about 100 mol %, and as another example about 40 to about 80 mol %, based on about 100 mol % of the units derived from dicarboxylic acid.

In some embodiments, the units derived from dicarboxylic acid may include units derived from terephthalic acid in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 mol %. Further, according to some embodiments of the present invention, the amount of units derived from terephthalic acid can be in a range from about any of the foregoing amounts to about any other of the foregoing amounts.

In exemplary embodiments of the present invention, the units derived from dicarboxylic acid comprise units derived from aromatic dicarboxylic acid other than terephthalic acid in an amount of about 0 to about 70 mol %, for example about 0 to about 60 mol %, and as another example about 20 to about 60 mol %, based on about 100 mol % of the units derived from dicarboxylic acid.

In some embodiments, the units derived from dicarboxylic acid may include units derived from aromatic dicarboxylic acid other than terephthalic acid in an amount of zero (the units derived from aromatic dicarboxylic acid other than terephthalic acid are not present), or about 0 (the units derived from aromatic dicarboxylic acid other than terephthalic acid are present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 mol %. Further, according to some embodiments of the present invention, the amount of units derived from aromatic dicarboxylic acid other than terephthalic acid can be in a range from about any of the foregoing amounts to about any other of the foregoing amounts.

In exemplary embodiments of the present invention, the units derived from dicarboxylic acid comprise units derived from aliphatic dicarboxylic acid having 4 to 20 carbon atoms, for example 6 to 12 carbon atoms, in an amount of about 0 to about 70 mol %, for example about 0 to about 60 mol %, and as another example about 20 to about 60 mol %, based on about 100 mol % of the units derived from dicarboxylic acid.

In some embodiments, the units derived from dicarboxylic acid may include units derived from aliphatic dicarboxylic acid in an amount of zero (the units derived from aliphatic dicarboxylic acid are not present), or about 0 (the units derived from aliphatic dicarboxylic acid units are present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 mol %. Further, according to some embodiments of the present invention, the amount of units derived from aliphatic dicarboxylic acid can be in a range from about any of the foregoing amounts to about any other of the foregoing amounts.

In exemplary embodiments of the present invention, the units derived from dicarboxylic acid comprise about 30 to about 100 mol % of units derived from terephthalic acid, and about 0 to about 70 mol % of units derived from aromatic dicarboxylic acid other than terephthalic acid, about 0 to about 70 mol % of units derived from aliphatic dicarboxylic acid having 4 to 20 carbon atoms or about 0 to about 70 mol % of units derived from aromatic dicarboxylic acid other than terephthalic acid and units derived from aliphatic dicarboxylic acid having 4 to 20 carbon atoms, based on about 100 mol % of the units derived from dicarboxylic acid.

In exemplary embodiments of the present invention, the units derived from dicarboxylic acid (a-1) may comprise a small amount, for example about 10 mol % or less, of units derived from polycarboxylic acid having 3 or more carboxyl groups. Examples of the polycarboxylic acid having 3 or more carboxyl groups comprise trimellitic acid, pyromellitic acid and the like, and combinations thereof.

(a-2) Units Derived from Diamine

The term “units derived from diamine” refers to residues of diamine from which hydrogens positioned at both ends of the diamine are removed. Examples of diamines comprise linear and/or branched aliphatic diamines having 4 to 20 carbon atoms, for example 6 to 12 carbon atoms.

Examples of the linear aliphatic diamine comprise without limitation 1,4-diaminobutane, 1,6-diaminohexane, 1,7-diaminoheptane, 1,8-diaminooctane, 1,9-diaminononane, 1,10-diaminodecane, 1,11-diaminoundecane, 1,12-diaminododecane and the like. These can be used alone or in combination thereof.

In exemplary embodiments of the present invention, the units derived from diamine comprise units derived from 1,6-diaminohexane in an amount of about 50 to about 100 mol %.

In some embodiments, the units derived from diamine comprise units derived from 1,6-diaminohexane in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 mol %. Further, according to some embodiments of the present invention, the amount of units derived from 1,6-diaminohexane can be in a range from about any of the foregoing amounts to about any other of the foregoing amounts.

Examples of the branched aliphatic diamine comprise without limitation 2-methyl-1,5-diaminopentane, 2-methyl-1,6-diaminohexane, 2-methyl-1,7-diaminoheptane, 2-methyl-1,8-diaminooctane, 2-methyl-1,9-diaminononane, 2-methyl-1,10-diaminodecane, 2-methyl-1,11-diaminoundecane and the like. These can be used alone or in combination thereof. In exemplary embodiments, 2-methyl-1,5-diaminopentane, 2-methyl-1,7-diaminoheptane, 2-methyl-1,8-diaminooctane and/or 2-methyl-1,9-diaminononane can be used.

The crystalline polyamide resin (A) can be prepared by known methods, and can be prepared by polycondensation of the dicarboxylic acid component and the diamine component. For example, as disclosed in International Patent Application Publication No. 2003-085029, the crystalline polyamide resin can be prepared by heating a dicarboxylic acid component and a diamine component in the presence of a catalyst to obtain a prepolymer, and polycondensing the prepolymer by imparting shearing stress to the molten material of the prepolymer.

In exemplary embodiments of the present invention, the crystalline polyamide resin (A) can have an intrinsic viscosity [η] of about 0.3 to about 0.9 dl/g, for example about 0.5 to about 0.9 dl/g, and as another example about 0.6 to about 0.9 dl/g measured in 96.5% sulfuric acid solution at 25° C. When the intrinsic viscosity of the crystalline polyamide resin is within the above range, excellent flowability during molding can be maintained.

In exemplary embodiments of the present invention, the crystalline polyamide resin (A) can have a melting point of about 260 to about 350° C., for example about 290 to about 335° C. measured by differential scanning calorimeter (DSC). In exemplary embodiments of the present invention, the crystalline polyamide resin (A) can have a crystallization temperature of about 260 to about 320° C., for example about 280 to about 300° C. measured by differential scanning calorimeter (DSC). In exemplary embodiments of the present invention, the crystalline polyamide resin (A) can have a glass transition temperature of about 100° C. or less measured by differential scanning calorimeter (DSC). When the melting point, the crystallization temperature and the glass transition temperature of the crystalline polyamide resin are within the above range, the composition can have excellent heat resistance. Typical examples of the crystalline polyamide resin having the above features comprise without limitation C3200 made by Mitsui Chemical Company (Japan) and A4002 made by Solvay Company (Belgium).

In exemplary embodiments of the present invention, the crystalline polyamide resin (A) comprises (a-1) units derived from dicarboxylic acid and (a-2) units derived from diamine, wherein the units derived from dicarboxylic acid (a-1) comprise about 30 to about 100 mol % of units derived from terephthalic acid, and about 0 to about 70 mol % of units derived from aromatic dicarboxylic acid other than terephthalic acid, about 0 to about 70 mol % of units derived from aliphatic dicarboxylic acid having 4 to 20 carbon atoms or about 0 to about 70 mol % of units derived from aromatic dicarboxylic acid other than terephthalic acid and units derived from aliphatic dicarboxylic acid having 4 to 20 carbon atoms, based on about 100 mol % of units derived from dicarboxylic acid; and the units derived from diamine (a-2) comprise units derived from linear and/or branched aliphatic diamine having 4 to 20 carbon atoms.

The polyamide resin composition can include the crystalline polyamide resin (A) in an amount of about 10 to about 70% by weight, for example about 10 to about 50% by weight, based on about 100% by weight of the crystalline polyamide resin (A), the amorphous polyamide resin (B), the inorganic filler (C) and the white pigment (D). In some embodiments, polyamide resin composition can include the crystalline polyamide resin (A) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70% by weight. Further, according to some embodiments of the present invention, the amount of crystalline polyamide resin (A) can be in a range from about any of the foregoing amounts to about any other of the foregoing amounts.

(B) Amorphous Polyamide Resin

The amorphous polyamide resin with a glass transition temperature of about 110 to about 200° C. according to the present invention can be prepared from the following monomers.

A linear and/or branched aliphatic dicarboxylic acid having 6 to 22 carbon atoms, for example adipic acid, 2,2,4-trimethyl adipic acid, 2,4,4-trimethyl adipic acid, azelaic acid, sebacic acid, 1,12-dodecane dicarboxylic acid and the like, and combinations thereof, can be used.

A ring-shaped aliphatic dicarboxylic acid having 6 to 22 carbon atoms, for example cyclohexane-1,4-dicarboxylic acid, 4,4′-dicarboxydicyclohexylpropane, 1,4-bis-carboxymethyl-cyclohexane and the like, and combinations thereof, can be used.

An aromatic dicarboxylic acid having 8 to 22 carbon atoms, for example 4, 4′-diphenylmethanedicarboxylic acid, isophthalic acid, tributyl isophthalic acid, terephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenylether-4,4′-dicarboxylic acid and the like, and combinations thereof can be used.

A linear and/or branched aliphatic diamine having 6 to 14 carbon atoms, for example 1,6-hexamethylene diamine, 2-methyl-1,5-diaminopentane, 2,2,4-trimethyl hexamethylene diamine, 2,4,4-trimethyl hexamethylene diamine, 1,9-nonamethylene diamine, 1,10-decamethylene diamine, 1,12-dodecamethylene diamine and the like, and combinations thereof can be used.

A ring-shaped aliphatic diamine having 6 to 22 carbon atoms, for example 4, 4′-diaminodicyclohexylmethane, 3,3′-dimethyl-4,4′-diaminodicyclohexylmethane, 4,4′-diaminodicyclopropane, 1,4-diaminocyclohexane, 1,4-bisaminomethylcyclohexane, 2,6-bisaminomethylnorbornene, 3-aminomethyl-3,5,5-trimethylcyclohexylamine and the like, and combinations thereof can be used.

An aromatic diamine having 8 to 22 carbon atoms, for example m-xylene diamine, p-xylene diamine, bis-4-aminophenylpropane and the like, and combinations thereof can be used.

A lactam having 6 to 12 carbon atoms, for example ε-caprolactam or laurolactam, ω-aminodicarboxylic acid, ε-aminocaproic acid, ω-aminododecanoic acid and the like, and combinations thereof can be used.

In exemplary embodiments of the present invention, the amorphous polyamide resin (B) can include polyamide prepared from terephthalic acid, 2,2,4-trimethyl hexamethylene diamine and 2,4,4-trimethyl hexamethylene diamine; polyamide prepared from isophthalic acid and 1,6-hexamethylene diamine; polyamide prepared from terephthalic acid, isophthalic acid and 1,6-hexamethylenediamine; copolyamide prepared from isophthalic acid, 3,3′-dimethyl-4,4′-diaminodicyclohexylmethane and laurolactam; polyamide prepared from 1,12-dodecane dicarboxylic acid and 4,4′-diaminodicyclohexylmethane; copolyamide prepared from terephthalic acid, isophthalic acid, 3,3′-dimethyl-4,4′-diaminodicyclohexylmethane and laurolactam; or a combination thereof.

In exemplary embodiments of the present invention, the amorphous polyamide resin (B) can have a glass transition temperature of about 110 to about 200° C., for example about 120 to about 160° C. measured by DSC. Examples of the amorphous polyamide resin having the above features comprise without limitation CX7323 made by Evonik Company (Germany) and G350 made by ARKEMA Company.

The polyamide resin composition can include the amorphous polyamide resin (B) in an amount of about 10 to about 70% by weight, for example about 10 to about 50% by weight, based on about 100% by weight of the crystalline polyamide resin (A), the amorphous polyamide resin (B), the inorganic filler (C) and the white pigment (D). In some embodiments, polyamide resin composition can include the amorphous polyamide resin (B) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70% by weight. Further, according to some embodiments of the present invention, the amount of amorphous polyamide resin (B) can be in a range from about any of the foregoing amounts to about any other of the foregoing amounts.

(C) Inorganic Filler

The strength of resin can be improved by adding inorganic filler (C) into the blend of the crystalline polyamide resin (A) and the amorphous polyamide resin (B). Inorganic fillers having various shapes, such as but not limited to fibers, powders, granules, plates, needles, cloths, mats and the like and combinations thereof, can be used. Examples of the inorganic filler include without limitation inorganic fibers such as glass fibers, metallic coated glass fibers, ceramic fibers, carbon fibers, metallic carbide fibers, metallic cured material fibers, asbestos fibers, boron fibers and the like and combinations thereof.

In exemplary embodiments, glass fiber can be used. Using glass fiber can help improve moldability of the composition. Also mechanical properties such as tensile strength, flexural strength, flexural modulus and the like and heat-resistant properties such as heat distortion temperature and the like of the molded article prepared from the resin composition can be improved.

In exemplary embodiments of the present invention, the glass fiber can have an average length of about 0.1 to about 20 mm, for example about 0.3 to about 6 mm, and an aspect ratio (L (average length of fiber)/D (average external diameter of fiber)) of about 10 to about 2,000, for example about 30 to about 600.

The polyamide resin composition can include the inorganic filler (C) in an amount of about 10 to about 60% by weight, for example about 10 to about 40% by weight, and as another example about 10 to about 30% by weight, based on about 100% by weight of the crystalline polyamide resin (A), the amorphous polyamide resin (B), the inorganic filler (C) and the white pigment (D). In some embodiments, polyamide resin composition can include the inorganic filler (C) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60% by weight. Further, according to some embodiments of the present invention, the amount of inorganic filler (C) can be in a range from about any of the foregoing amounts to about any other of the foregoing amounts.

(D) White Pigment

Examples of the white pigment (D) comprise without limitation titanium oxide, zinc sulfide, white lead, zinc sulfate, aluminum oxide and the like. These can be used alone or in combination thereof. White pigment treated with silane coupling agent, titanium coupling agent and the like can also be used. For example, white pigment surface-treated with a silane-based compound such as vinyltriethoxysilane, 2-aminopropyltriethoxysilane, 2-glycidoxypropyltriethoxysilane and the like can be used. In exemplary embodiments, the white pigment can include titanium oxide.

Optical properties such as reflectance, concealment property and the like can be improved by using the titanium oxide. In exemplary embodiments, the titanium oxide can have a standard shape. The average particle diameter of the titanium oxide can be about 0.05 to about 2.0 μm, for example about 0.05 to about 0.7 μm.

The polyamide resin composition can include the white pigment (D) in an amount of about 10 to about 50% by weight, for example about 10 to about 40% by weight, and as another example about 10 to about 35% by weight, based on about 100% by weight of the crystalline polyamide resin (A), the amorphous polyamide resin (B), the inorganic filler (C) and the white pigment (D). In some embodiments, the polyamide resin composition can include the white pigment (D) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of the white pigment (D) can be in a range from about any of the foregoing amounts to about any other of the foregoing amounts.

(E) Light Stabilizer

The polyamide resin composition according to the present invention may further comprise a light stabilizer to prevent discoloration and inhibit degradation of light reflectance. Examples of the light stabilizer comprise without limitation compounds able to absorb UV such as benzophenone-based compounds, salicylate-based compounds, benzotriazole-based compounds, acrylonitrile-based compounds, other resonance-based compounds and the like; compounds able to capture radicals such as hindered amine-based compounds, hindered phenol-based compounds and the like; and combinations thereof.

In exemplary embodiments, a compound that has high solubility in a mixture of the crystalline polyamide resin (A) and amorphous polyamide resin (B), excellent heat resistance, and amide bonds in the molecule can be used. Also, using both a compound able to absorb UV and a compound able to capture radicals can improve light stability.

Depending on the effect of preventing discoloration and inhibiting degradation of light reflectance of the polyamide resin composition, the polyamide resin composition can include the light stabilizer (E) in an amount of about 0.05 to about 2 parts by weight, for example about 0.1 to about 2 parts by weight, based on about 100 parts by weight of the crystalline polyamide resin (A), the amorphous polyamide resin (B), the inorganic filler (C) and the white pigment (D). In some embodiments, the polyamide resin composition can include the light stabilizer (E) in an amount of about 0.05, 0.06, 0.07, 0.08, 0.09, 0.1, 0.2, 0.3, 0.4, 0.5, 0.6, 0.7, 0.8, 0.9, 1, or 2 parts by weight. Further, according to some embodiments of the present invention, the amount of the light stabilizer (E) can be in a range from about any of the foregoing amounts to about any other of the foregoing amounts.

(F) Inorganic Particle

The polyamide resin composition according to the present invention can further comprise inorganic particles to inhibit degradation of light reflectance. Examples of the inorganic particle comprise without limitation calcium carbonate, magnesium carbonate, zinc carbonate, zinc oxide, barium sulfate, zinc sulfide, alkaline carbonate, titanated mica, antimony oxide, magnesium oxide, calcium phosphate, silica, alumina, mica, talc, kaolin and the like. These can be used alone or in combination thereof.

The polyamide resin composition can include the inorganic particle (F) in an amount of about 0.05 to about 3 parts by weight, for example about 0.05 to about 2 parts by weight, based on about 100 parts by weight of the crystalline polyamide resin (A), the amorphous polyamide resin (B), the inorganic filler (C) and the white pigment (D). In some embodiments, the polyamide resin composition can include the inorganic particle (F) in an amount of about 0.05, 0.06, 0.07, 0.08, 0.09, 0.1, 0.2, 0.3, 0.4, 0.5, 0.6, 0.7, 0.8, 0.9, 1, 2, or 3 parts by weight. Further, according to some embodiments of the present invention, the amount of the inorganic particle (F) can be in a range from about any of the foregoing amounts to about any other of the foregoing amounts.

(G) Additives

The polyamide resin composition according to the present invention can further comprise one or more additives. Examples of the additives include without limitation antioxidants, heat stabilizers, flame retardants, fluorescent whitening agents, plasticizers, thickeners, antistatic agents, release agents, pigments, nucleating agents and the like, and combinations thereof, depending on the use of the composition, so long as the additives have minimal negative impact on the properties of the composition. Examples of the antioxidants comprise without limitation phenol-based compounds, amine-based compounds, sulfur-based compounds, phosphorus-based compounds and the like, and combinations thereof. Examples of the heat stabilizer comprise without limitation lactone compounds, hydroquinone-based compounds, halogenated copper, iodine compounds and the like, and combinations thereof. Examples of the flame retardant comprise without limitation bromine-based compounds, chlorine-based compounds, phosphorus-based compounds, antimony-based compounds, inorganic compounds and the like, and combinations thereof.

Also, the polyamide resin composition according to the present invention can further comprise an olefin-based copolymer or modified olefin-based copolymer such as ethylene-methylacrylate copolymer, ethylene-ethylacrylate copolymer, ethylene-propylene copolymer, ethylene-1-butene copolymer, propylene-1-butene copolymer and the like; other polymers such as but not limited to polystyrene, fluorine resin, silicone resin, liquid crystal polymer and the like, and combinations thereof, depending on the use of the composition, so long as the additives have minimal negative impact on the properties of the composition.

The polyamide resin composition according to the present invention can be prepared by known methods, for example by mixing all components using a henschel mixer, V blender, ribbon blender, tumbler blender and the like, and after mixing further melting-mixing the mixture by means of a single-screw extruder, multi-screw extruder, kneader, banbury mixer and the like. The composition can be extruded in the form of pellets, which can be pulverized, or can be directly extruded into a molded article.

The polyamide resin composition according to the present invention can have excellent light reflectance, heat resistance, and adhesion with a sealing resin such as epoxy resin. Further, when the polyamide resin composition is used as a reflector for a LED, degradation of reflectance can be inhibited.

The present invention also provides a molded article prepared from the polyamide resin composition. For example, the polyamide resin composition according to the present invention can be prepared into a reflector for a LED by heat molding such as injection molding (insert molding of metal such as hoop molding), melt molding, extrusion molding, inflation molding, blow molding and the like. Also, the reflector for a LED prepared from the polyamide resin composition according to the present invention along with common LED elements and other parts can be sealed, connected or bonded by a sealing resin.

The polyamide resin composition and the molded article prepared from the same according to the present invention can be used in other products reflecting light, as well as in LEDs. For example, a reflector prepared from the polyamide resin composition according to the present invention can be used as a reflector for light-emitting devices of various electrical or electronic parts, interior lighting, ceiling lighting, outside lighting, automobile lighting, display units, head lights and the like. The polyamide resin composition according to the present invention can be molded into a reflector by known methods, for example heating and melting the polyamide resin composition, molding using a desired mold, and cooling. Also, the polyamide resin composition can be molded into a reflector by known methods, for example injection molding, compression molding, extrusion molding and the like.

In exemplary embodiments of the present invention, the molded article can have a reflectance at a 440 nm wavelength light of about 70 to about 100%, for example about 80 to about 90%, and as another example about 85 to about 90%, which is measured after the molded article is illuminated by a LED light source having a wavelength of 460 nm for 200 hours.

In exemplary embodiments of the present invention the molded article can have a yellow index of about 1 to about 10, for example about 1 to about 5, and as another example about 1 to about 4.5, which is measured after the molded article is illuminated by a LED light source having a wavelength of 460 nm for 200 hours.

The invention may be better understood by reference to the following examples which are intended for the purpose of illustration and are not to be construed as in any way limiting the scope of the present invention, which is defined in the claims appended hereto.

### EXAMPLES

The specifications of each component used in the following examples and comparative examples are as follows.

(A) Crystalline Polyamide Resin

C3200 made by Mitsui Chemical Company (Japan) and having a melting point of 320° C. measured by DSC, a crystallization temperature of 288° C. measured by DSC and a glass transition temperature of 85° C. measured by DSC is used.

(B) Amorphous Polyamide Resin

CX7323 made by Evonik Company (Germany) and having a glass transition temperature of 142° C. measured by DSC and no crystallization temperature when measuring by DSC is used.

(C) Inorganic Filler

CS 910 made by OCV reinforcements Company (USA) is used.

(D) White Pigment

TiO₂ 2233 made by KRONOS Company (USA) is used.

(E) Light Stabilizer

CHIMASSORB944 made by BASF Company (Germany) is used.

### Examples 1-4 and Comparative Examples 1-4

In a conventional mixer each component, antioxidant, heat stabilizer and releasing agent are added and mixed. The mixture is extruded by a twin screw extruder with L/D of 35 and diameter of 45 mm at a temperature of 250 to 350° C. to prepare pellets. The pellets are prepared into a specimen in the form of a plate (length: 90 mm, width: 49 mm, thickness: 2.5 mm) by a 10 oz injection molding machine at an injection temperature of 320 to 340° C. The specimen is left at a temperature of 23° C. and relative humidity of 50% for 48 hours, and then the properties of the specimen are measured in accordance with the following methods. The results are set forth in Table 1.

Methods for Measuring Properties

[Melting Point]

Using a DSC7 made by PerkinElemer Company, the temperature is maintained at 330° C. for 5 minutes, the temperature is decreased to 23° C. at a rate of 10° C./min and the temperature is increased at the rate of 10° C./min. Heat absorption peak when dissolved is determined as the melting point.

[Crystallization Temperature]

Using a DSC7 made by PerkinElemer Company, the temperature is maintained at 330° C. for 5 minutes. The peak of phase transition temperature, which occurs while the temperature is decreased to 23° C. at a rate of 10° C./min, is determined as the crystallization temperature.

[Glass Transition Temperature]

Using a DSC7 made by PerkinElemer Company, the temperature is maintained at 330° C. for 5 minutes, the temperature is decreased to 23° C. at a rate of 10° C./min and the temperature is increased at a rate of 10° C./min Second-order endothermic transition point before melting point is determined as the glass transition temperature.

[Reflectance]

Using a specimen in the form of a plate, the reflectance at a 440 nm wavelength light is measured. The initial reflectance is measured, and the reflectance is measured after the specimen is illuminated by a LED light source having a wavelength of 460 nm for 200 hours under constant temperature and humidity conditions, and in particular in an oven at a temperature of 85° C. and relative humidity of 85%. CM3500d made by KONICA MINOLTA HOLDINGS, INC. is used as the instrument for measuring reflectance.

[Evaluation of Delamination Property]

Evaluation of delamination (release) property is conducted to determine whether or not the release property of the composition is poor when injection-molding the polyamide resin composition or to determine if a delamination (release) phenomenon due to the blend with a different kind of resin. An article with a length of 3 mm, width of 2.5 mm and height of 2 mm in the form of cup is prepared by hoop molding. Aqueous ink is dropped into the contact area of hoop material and the article in the form of cup. Whether or not the aqueous ink permeates into the contact surface of the hoop material and the article in the form of cup due to the capillary phenomenon is evaluated with the naked eye. The initial delamination property is evaluated, and the delamination property is evaluated after the hoop material and the article are left in a constant temperature (in particular in an oven) of 170° C. for 3 hours.

∘: no permeation, Δ: small amount permeation, x: large amount permeation

[Yellow Index]

The yellow index of a specimen with a thickness of 2.5 mm is measured in accordance with ASTM D1925 using a colorimeter Minolta Spectrophotometer 3600D using the CIE Lab color difference evaluation criteria. The initial yellow index is measured, and the yellow index is measure after the specimen is illuminated by a LED light source having a wavelength of 460 nm for 200 hours under constant temperature and humidity conditions, and in particular in an oven at a temperature of 85° C. and a relative humidity of 85%.

TABLE 1

| | | Examples | | | | Comparative Examples | | | |
|---|---|---|---|---|---|---|---|---|---|
| | | 1 | 2 | 3 | 4 | 1 | 2 | 3 | 4 |
| (A) Crystalline Polyamide (wt %) | | 50 | 40 | 10 | 30 | 60 | — | 40 | 50 |
| (B) Amorphous Polyamide (wt %) | | 10 | 20 | 50 | 30 | — | 60 | 20 | 10 |
| (C) Inorganic Filler (wt %) | | 15 | 10 | 15 | 15 | 10 | 15 | 5 | 15 |
| (D) White Pigment (wt %) | | 25 | 30 | 25 | 25 | 30 | 25 | 35 | 25 |
| (E) Light Stabilizer (parts by weight) | | 0.5 | 1 | 1 | 0.5 | 1.5 | 1 | 1 | 5 |
| Reflectance (%) | Initial | 93 | 92 | 92 | 93 | 89 | 92 | 87 | 91 |
| | After 200 hours | 90 | 90 | 89 | 89 | 75 | 62 | 64 | 87 |
| Evaluation of | Initial | ◯ | ◯ | ◯ | ◯ | | ◯ | | ◯ |
| Delamination | 170° C., | ◯ | ◯ | ◯ | ◯ | X | X | X | ◯ |
| Property | After 3 hours | | | | | | | | |
| Yellow Index | Initial | 3.1 | 3.5 | 3.6 | 3.5 | 4.6 | 5.0 | 2.0 | 8.2 |
| | After 200 hours | 4.5 | 4.3 | 4.0 | 4.2 | 8.4 | 12.5 | 4.5 | 22.5 |

As shown in Table 1, Examples 1 to 4 maintain a reflectance of 85% or more after the specimen is illuminated by a LED light source having a wavelength of 460 nm for 200 hours under constant temperature and humidity conditions of 85° C. and relative humidity of 85%. However, when the crystalline polyamide resin or the amorphous polyamide resin is used alone (Comparative Example 1 or 2) and the inorganic filler is used in an amount outside of the present invention (Comparative Example 3), the reflectance is significantly decreased after the specimen is illuminated by a LED light source having a wavelength of 460 nm for 200 hours under constant temperature and humidity conditions of a temperature of 85° C. and relative humidity of 85%.

Also, when the light stabilizer is present in an amount outside of the amount of the present invention (Comparative Example 4), the initial yellow index is increased and the yellow index is significantly increased after the specimen is illuminated by a LED light source having a wavelength of 460 nm for 200 hours under constant temperature and humidity conditions of a temperature of 85° C. and relative humidity of 85%.

Also, when the amorphous polyamide resin is used alone (Comparative Example 2), the initial yellow index is good but the yellow index significantly increases after the specimen is illuminated by a LED light source having a wavelength of 460 nm for 200 hours under constant temperature and humidity conditions of a temperature of 85° C. and a relative humidity of 85%. If the yellow index is increased, when the light derived from a LED light source is illuminated onto a LED reflector, the absorbable amount of incident light of the reflector is increased, and thereby the efficiency of the LED light source deteriorates.

Also, when the crystalline polyamide rein is used alone (Comparative Example 1), and the inorganic filler is included in an amount outside of the present invention (Comparative Example 3), permeation phenomenon of aqueous ink appears during the initial evaluation of the delamination property and the evaluation of the delamination property after the hoop material and the article are left at a constant temperature of 170° C. for 3 hours. When the amorphous polyamide resin is used alone (Comparative Example 2), the initial evaluation of delamination property is good but permeation phenomenon of aqueous ink appears during the evaluation of delamination property after the hoop material and the article are left at a constant temperature of 170° C. for 3 hours.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. A polyamide resin composition comprising:
(A) about 10 to about 70% by weight of crystalline polyamide resin;
(B) about 10 to about 70% by weight of amorphous polyamide resin with a glass transition temperature of about 110 to about 200° C.;
(C) about 10 to about 60% by weight of inorganic filler;
(D) about 10 to about 50% by weight of white pigment, and
(E) about 0.05 to about 2 part by weight of light stabilizer, based on about 100 parts by weight of the crystalline polyamide resin (A), the amorphous polyamide resin (B), the inorganic filler (C) and the white pigment (D).

2. The polyamide resin composition of claim 1, further comprising (F) about 0.05 to about 3 parts by weight of inorganic particles, based on about 100 parts by weight of the crystalline polyamide resin (A), the amorphous polyamide resin (B), the inorganic filler (C) and the white pigment (D).

3. The polyamide resin composition of claim 1, wherein the crystalline polyamide resin (A) has a melting point of about 260 to about 350° C., a crystallization temperature of about 260 to about 320° C., and a glass transition temperature of less than about 100° C.

4. The polyamide resin composition of claim 1, wherein the crystalline polyamide resin (A) comprises (a-1) units derived from dicarboxylic acid and (a-2) units derived from diamine; and the units derived from dicarboxylic acid (a-1) comprise about 30 to about 100 mol % of units derived from terephthalic acid, and about 0 to about 70 mol % of units derived from aromatic dicarboxylic acid other than terephthalic acid, about 0 to about 70 mol % of units derived from C4 to C20 aliphatic dicarboxylic acid or about 0 to about 70 mol % of a combination of units derived from aromatic dicarboxylic acid other than terephthalic acid and units derived from C4 to C20 aliphatic dicarboxylic acid; and the units derived from diamine (a-2) comprise units derived from C4 to C20 linear aliphatic diamine, C4 to C20 branched aliphatic diamine, or a combination thereof.

5. The polyamide resin composition of claim 1, wherein the amorphous polyamide resin (B) has a glass transition temperature of about 120 to about 160° C.

6. The polyamide resin composition of claim 1, wherein the amorphous polyamide resin (B) comprises a polyamide prepared from terephthalic acid, 2,2,4-trimethyl hexamethylene diamine and 2,4,4-trimethyl hexamethylene diamine; polyamide prepared from isophthalic acid and 1,6-hexamethylene diamine; polyamide prepared from terephthalic acid, isophthalic acid and 1,6-hexamethylene diamine; copolyamide prepared from isophthalic acid, 3,3′-dimethyl-4,4′-diaminodicyclohexylmethane and laurolactam; polyamide prepared from 1,12-dodecane dicarboxylic acid and 4,4′-diaminodicyclohexylmethane; copolyamide prepared from terephthalic acid, isophthalic acid, 3,3′-dimethyl-4,4′-diaminodicyclohexylmethane and laurolactam; or a combination thereof.

7. The polyamide resin composition of claim 1, wherein the inorganic filler (C) comprises a glass fiber with an average length of about 0.1 to about 20 mm and an aspect ratio of about 10 to about 2,000.

8. The polyamide resin composition of claim 1, wherein the white pigment (D) comprises titanium oxide, zinc sulfide, white lead, zinc sulfate, aluminum oxide or a combination thereof.

9. The polyamide resin composition of claim 1, wherein the light stabilizer (E) comprises a hindered amine-based compound.

10. The polyamide resin composition of claim 2, wherein the inorganic particle (F) comprises calcium carbonate, magnesium carbonate, zinc carbonate, zinc oxide, barium sulfate, zinc sulfide, alkaline carbonate, titanated mica, antimony oxide, magnesium oxide, calcium phosphate, silica, alumina, mica, talc, kaolin or a combination thereof.

11. The polyamide resin composition of claim 1, further comprising an additive comprising an antioxidant, heat stabilizer, flame retardant, fluorescent whitening agent, plasticizer, thickener, antistatic agent, release agent, pigment, nucleating agent or a combination thereof.

12. A molded article prepared from the polyamide resin composition of claim 1.

13. The molded article of claim 12, having a reflectance of about 80 to about 90% at a 440 nm wavelength light, which is measured after the molded article is illuminated by a LED light source having a wavelength of 460 nm for 200 hours.

14. The molded article of claim 12, having a yellow index of about 1 to about 5, which is measured after the molded article is illuminated by a LED light source having a wavelength of 460 nm for 200 hours.
